(19) United States
(12) Patent Application Publication
(10) Pub. No.: US 2019/0204887 A1
(43) Pub. Date: Jul. 4, 2019

(54) BACKUP POWER SUPPLY METHOD AND APPARATUS

(71) Applicant: Huawei Technologies Co., Ltd., Shenzhen (CN)

(72) Inventors: Dahong YAN, Chengdu (CN); Hongdong ZHANG, Chengdu (CN)

(21) Appl. No.: 16/294,677

(22) Filed: Mar. 6, 2019

Related U.S. Application Data
(63) Continuation of application No. PCT/CN2017/100285, filed on Sep. 1, 2017.

(30) Foreign Application Priority Data
Sep. 7, 2016 (CN) 201610808587.8

(51) Int. Cl. G06F 1/26; G06F 1/28; G06F 11/14

(52) U.S. Cl. CPC G06F 1/263; G06F 11/1441; G06F 1/28

(57) ABSTRACT

A backup power supply method is provided. After detecting a host is powered off, a power-on/off management device in the host powers off elements in the host except a processor, a memory, a backup power hard disk, and a BIOS memory; sets a power-off flag in the power-on/off management device, and sends a reboot instruction to the processor. after receiving the reboot instruction, the processor runs a BIOS program stored in the BIOS memory to initialize the elements in the host except the memory when the power-off flag is detected; store to-be-stored data of the memory into the backup power hard disk; and power off all the elements in the host.

### CROSS-REFERENCE TO RELATED APPLICATIONS

This application is a continuation of International Application No. PCT/CN2017/100285, filed on Sep. 1, 2017, which claims priority to Chinese Patent Application No. 201610808587.8, filed on Sep. 7, 2016. The disclosures of the aforementioned applications are hereby incorporated by reference in their entireties.

### TECHNICAL FIELD

The embodiments of present application relates to the field of computer technologies, and in particular, to a backup power supply method and an apparatus.

### BACKGROUND

When a computer is powered off, data of a memory in the computer may be lost. Therefore, to ensure that the data of the memory is not lost, a backup power supply module (for example, a capacitor module) in the computer may supply backup power to the computer, and during the supply of backup power, a processor in the computer stores the data of the memory.

When the backup power supply module in the computer usually supplies backup power to the computer, the backup power supply module supplies backup power to all elements in the computer. In other words, the backup power supply module supplies backup power to all the elements in the computer.

However, the backup power supply module supplies backup power to all the elements in the computer, and a battery capacity of the backup power supply module is usually limited. Therefore, the backup power supply module may supply backup power to the computer for a shorter time. In addition, some elements (such as a Peripheral Component Interconnect Express interface card) in all the elements in the computer may not need to operate after the computer is powered off. Therefore, to enable the backup power supply module to supply backup power to the computer for a longer time, these elements in the computer may be directly powered off. However, because these elements may not support hot swapping, if these elements are directly powered off, the computer may encounter an exception, and consequently the processor cannot normally store the data of the memory.

### SUMMARY

This application provides a backup power supply method and an apparatus, to avoid an exception on a computer while a backup power supply module supplies backup power to the computer for a longer time, so that a processor in the computer can normally store data of a memory.

To achieve the foregoing objective, the following technical solutions are used in this application:

According to a first aspect, a backup power supply method is provided. The method is applied to a host and the method includes: after detecting that the host is powered off, powering off, by a power-on/off management device in the host, elements in the host except a processor, a memory, a backup power hard disk, and a BIOS memory; setting, by the power-on/off management device, a power-on/off flag to a power-off flag in the power-on/off management device, and sending a reboot instruction to the processor; after receiving the reboot instruction, running, by the processor in the host, a BIOS program stored in the BIOS memory, to perform the following operations: detecting the power-on/off flag, and initializing the elements in the host except the memory when the power-on/off flag is the power-off flag; storing, by the processor in the host in the backup power hard disk, to-be-stored data of the memory; and powering off, by the processor in the host, all the elements in the host after storing the to-be-stored data in the backup power hard disk.

According to the backup power supply method provided in this application, when the power-on/off management device in the host detects that the host is powered off, the power-on/off management device can power off the elements in the host except elements (for example, the processor, the memory, the backup power hard disk, and the BIOS memory) that need a backup power supply. In other words, a backup power supply module supplies backup power only to the elements in the host that need a backup power supply. Therefore, compared with the prior art, in this application, the backup power supply module can supply backup power to the host for a longer time. In addition, after the power-on/off management device in the host powers off the elements in the host except the elements that need a backup power supply, the power-on/off management device can send the reboot instruction to the processor in the host, to reboot the processor. After being rebooted, the processor runs the BIOS program to: detect that the power-on/off flag is the power-off flag, and initialize the elements in the host except the memory; and store, in the backup power hard disk, the to-be-stored data of the memory, and then power off all the elements in the host. Therefore, compared with the prior art, in this application, the following case can be avoided: The host encounters an exception after the power-on/off management device in the host powers off the elements in the host except the elements that need a backup power supply, so that the processor in the host can normally store the to-be-stored data of the memory. In this way, according to the backup power supply method provided in this application, an exception on the host can be avoided while the backup power supply module supplies backup power to the host for a longer time, so that the processor in the host can normally store the to-be-stored data of the memory.

Further, the backup power supply module supplies backup power to the host for a longer time. Therefore, it can be ensured, to a specific degree, that all the to-be-stored data of the memory is successfully stored.

The elements that need no backup power supply may include a PCIe interface card, a data disk, a fan, and the like. The data disk is not the foregoing backup power hard disk.

In a first optional implementation of the first aspect, before the processor in the host stores, in the backup power hard disk, the to-be-stored data of the memory in the host, the processor in the host may further determine a state of the backup power hard disk in the host, and select a normal-state backup power hard disk as the backup power hard disk that stores the to-be-stored data of the memory.

In this embodiment of the present application, one or more backup power hard disks may be configured to store the to-be-stored data of the memory.

When a plurality of backup power hard disks are configured to store the to-be-stored data of the memory, the host may select a normal backup power hard disk to store the to-be-stored data of the memory. In this way, it can be more reliable for the host to successfully store the to-be-stored data of the memory.

In a second optional implementation of the first aspect, in a process in which the processor in the host stores, in the backup power hard disk, the to-be-stored data of the memory in the host, the processor in the host may further send a cache clear command (namely, a flush command) to the backup power hard disk. The flush command is used to instruct the processor in the host to write, to a persistent storage medium in the backup power hard disk, all data of a cache in the backup power hard disk.

In this application, the processor in the host sends the flush command to the backup power hard disk. Therefore, it can be ensured that all the data of the cache in the backup power hard disk is written to the persistent storage medium in the backup power hard disk.

In a third optional implementation of the first aspect, after all the to-be-stored data of the memory is stored in the backup power hard disk, the processor in the host may further set a data storage validity flag that is used to indicate that all the to-be-stored data of the memory is successfully stored.

In a fourth optional implementation of the first aspect, the backup power supply method provided in this application may further include: after the power-on/off management device in the host detects that the host is powered on, setting, by the power-on/off management device, the power-on/off flag to a power-on flag in the power-on/off management device; when the processor in the host detects that the power-on/off flag is the power-on flag, restoring, by the processor in the host to the memory, the to-be-restored data stored in the backup power hard disk; and booting, by the processor in the host, an operating system.

In this application, after detecting that the host is powered on, the power-on/off management device in the host may set the power-on/off flag to the power-on flag. Therefore, when the processor in the host detects that the power-on/off flag is the power-on flag, the processor may restore, to the memory, the to-be-restored data (the data stored by the processor from the memory to the backup power hard disk when the host is powered off) stored in the backup power hard disk, and then the processor boots the operating system of the host. In this way, after being normally booted, the host can restore to a state in which the host is before being powered off.

In a fifth optional implementation of the first aspect, in a process of running the BIOS program, the processor in the host may configure, in the memory in the host, a size of a cache in the processor based on a requirement of a service performed before the host is powered off. For example, a size of the memory in the host is 64 GB. The processor in the host may partition the memory to obtain a 2 GB partition as the cache in the processor.

In this application, in the process of running the BIOS program, the processor in the host may first initialize all the elements in the host, and then configure the size of the cache in the processor in the host based on the requirement of the service. In this way, the following problem can be avoided: A configured cache becomes invalid because a size of the configured cache is initialized.

In a sixth optional implementation of the first aspect, before the processor in the host restores the to-be-restored data stored in the backup power hard disk, the processor in the host may further determine a state of the backup power hard disk in the host, select a normal-state backup power hard disk that stores the to-be-restored data, and then restore the to-be-restored data in the backup power hard disk to the memory.

In a seventh optional implementation of the first aspect, after the processor in the host selects the normal-state backup power hard disk that stores the to-be-restored data, the processor in the host may further determine whether the to-be-restored data stored in the backup power hard disk is valid (to be specific, whether the processor in the host has successfully stored, in the backup power hard disk, all the to-be-stored data of the memory when the host is powered off).

In this application, the processor in the host may read the data storage validity flag that is set by the processor in the host after all the to-be-stored data is successfully stored in a process of storing the to-be-stored data of the memory, to learn that the to-be-restored data stored in the backup power hard disk is valid.

In an eighth optional implementation of the first aspect, when the host is normally running, system management software that is run by the processor in the host can monitor, in real time, whether the backup power supply module is fully charged. Therefore, a charging status of the backup power supply module can be learned of in real time.

In a ninth optional implementation of the first aspect, the system management software that is run by the processor in the host can further monitor, in real time, whether the backup power supply module is faulty, and generate an alarm when the backup power supply module is faulty. In this way, it can be ensured that a fault occurring in the backup power supply module is found in a timely manner.

According to a second aspect, a host is provided. The host includes a power-on/off management device, a processor, a memory, a backup power hard disk, and a BIOS memory. The power-on/off management device is configured to: after detecting that the host is powered off, power off elements in the host except the processor, the memory, the backup power hard disk, and the BIOS memory; and set a power-on/off flag to a power-off flag in the power-on/off management device, and send a reboot instruction to the processor. The processor is configured to: after receiving the reboot instruction, run a BIOS program stored in the BIOS memory, to perform the following operations: detecting the power-on/off flag, and initializing the elements in the host except the memory when the power-on/off flag is the power-off flag; storing, by the processor in the backup power hard disk, to-be-stored data of the memory; and powering off, by the processor, all the elements in the host after storing the to-be-stored data in the backup power hard disk.

In a first optional implementation of the second aspect, the power-on/off management device is further configured to: after detecting that the host is powered on, set the power-on/off flag to a power-on flag in the power-on/off management device; and the processor is further configured to: when detecting that the power-on/off flag is the power-on flag, restore, to the memory, the to-be-restored data stored in the backup power hard disk; and boot an operating system.

For detailed descriptions of other optional implementations of the second aspect, refer to the foregoing related descriptions of the optional implementations of the first aspect. Details are not described herein again.

For detailed descriptions of technical effects of the second aspect and the optional implementations of the second aspect, refer to the foregoing related descriptions of the technical effects of the first aspect and the optional implementations of the first aspect. Details are not described herein again.

According to a third aspect, a computer readable storage medium is provided. The computer readable storage medium stores one or more programs, the one or more programs include an instruction, and the processor and the power-on/off management device in the foregoing host can execute the instruction to perform the backup power supply method according to the first aspect and the optional implementations of the first aspect.

For descriptions of technical effects of the third aspect, refer to the foregoing related descriptions of the technical effects of the first aspect and the optional implementations of the first aspect. Details are not described herein again.

### BRIEF DESCRIPTION OF DRAWINGS

To describe the technical solutions in the embodiments of the present application more clearly, the following briefly describes the accompanying drawings required for describing the embodiments. Apparently, the accompanying drawings in the following descriptions show merely some embodiments of the present application.

FIG. 1 is a first schematic hardware diagram of a host according to an embodiment of the present application;

FIG. 2 is a first schematic diagram of a backup power supply method according to an embodiment of the present application;

FIG. 3A and FIG. 3B are a second schematic diagram of a backup power supply method according to an embodiment of the present application; and

FIG. 4 is a second schematic hardware diagram of a host according to an embodiment of the present application.

### DESCRIPTION OF EMBODIMENTS

The following describes the technical solutions in embodiments of the present application in detail with reference to the accompanying drawings in the embodiments of the present application. Apparently, the described embodiments are merely some but not all of the embodiments of the present application.

The term “and/or” in this specification describes only an association relationship for describing associated objects and indicates that three relationships may exist. For example, A and/or B may indicate the following three cases: Only A exists, both A and B exist, and only B exists.

In the embodiments of the present application, the word “example”, “for example”, or the like is used to indicate giving an example, an illustration, or a description. Any embodiment or design scheme described by using “example” or “for example” in the embodiments of the present application should not be explained as being more preferred or having more advantages than another embodiment or design scheme. Exactly, use of the word “example”, “for example”, or the like is intended to present a related concept in a specific manner.

In the descriptions of the present application, unless otherwise specified, “a plurality of” means “two or more”. For example, a plurality of backup power supply modules means two or more backup power supply modules.

The following first explains some concepts related to a backup power supply method and an apparatus according to the embodiments of the present application.

A basic input/output system (basic input/output system, BIOS) memory is a chip into which a BIOS program is built. The chip may be a random access memory (random access memory, RAM), a read-only memory (read-only memory, ROM), or the like.

The BIOS program includes a basic input/output program, a power-on self-test program, and a system auto-boot program of a host. After the host is booted (for example, is normally booted or is rebooted), the host first runs the BIOS program (specifically, a processor in the host may run the BIOS program). The host can run the BIOS program to provide the host with most underlying and most direct hardware and/or software setting and control.

Backup power supply means that a backup power supply module supplies backup power to the host when the host is powered off.

Power-on means that an external power source supplies power to the host.

A power-on/off management device in the host is a complex programmable logical device (complex programmable logical device, CPLD).

The CPLD is a digital integrated circuit whose logical function is constructed by a user based on a requirement. Certainly, the power-on/off management device in the embodiments of the present application may be another chip or element that can monitor a power-on/off state of the host. Details are not described herein.

The backup power supply method and the apparatus that are provided in the embodiments of the present application may be applied to a scenario (referred to as a scenario 1 below) in which backup power is supplied to a host when the host is powered off, and applied to a scenario (referred to as a scenario 2 below) in which a host is powered on again after the host is powered off.

In the scenario 1, when the host is powered off, data of a memory (the memory is a volatile storage medium) may be lost. Therefore, a backup power supply module needs to supply backup power to the host, so that the data of the memory can be temporarily stored in a non-volatile storage medium (for example, a backup power hard disk that may be specifically a system disk or a data disk in the host). Specifically, in the embodiments of the present application, when a power-on/off management device in the host detects that the host is powered off, the power-on/off management device can power off elements in the host except elements (for example, a processor, a memory, the backup power hard disk, and a BIOS memory) that need a backup power supply, and send a reboot instruction to the processor. After the processor receives the reboot instruction, the processor is rebooted. During booting, the processor runs a BIOS program to store to-be-stored data of the memory.

In the scenario 2, when the host is powered on after the host is powered off, to restore the host to a state in which the host is before being powered off, data temporarily stored in a non-volatile storage medium (for example, a backup power hard disk that may be specifically a system disk or a data disk in the host) after the host is powered off needs to be restored to a memory. Specifically, in this embodiment of the present application, when a power-on/off management device in the host detects that the host is powered on, during normal booting, a processor in the host runs a BIOS program to restore to-be-restored data. The to-be-restored data is the data of the memory that is temporarily stored in the non-volatile storage medium after the host is powered off.

It should be noted that, for ease of understanding of the technical solutions in the embodiments of the present application, all the following embodiments are illustrated by using an example in which the non-volatile storage medium is the backup power hard disk.

In the scenario 1, according to the backup power supply method and the apparatus that are provided in the embodiments of the present application, when the power-on/off management device in the host detects that the host is powered off, the power-on/off management device can power off the elements in the host except the elements (for example, the processor, the memory, the backup power hard disk, and the BIOS memory) that need a backup power supply. In other words, the backup power supply module supplies backup power only to the elements in the host that need a backup power supply. Therefore, compared with the prior art, in the embodiments of the present application, the backup power supply module can supply backup power to the host for a longer time. In addition, after the power-on/off management device in the host powers off the elements in the host except the elements that need a backup power supply, the power-on/off management device can send the reboot instruction to the processor in the host, to reboot the processor. After being rebooted, the processor runs the BIOS program to: detect that a power-on/off flag is a power-off flag, and initialize the elements in the host except the memory; and store, in the backup power hard disk, the to-be-stored data of the memory, and then power off all the elements in the host. Therefore, compared with the prior art, in the embodiments of the present application, the following case can be avoided: The host encounters an exception after the power-on/off management device in the host powers off the elements in the host except the elements that need a backup power supply, so that the processor in the host can normally store the to-be-stored data of the memory. In this way, according to the backup power supply method and the apparatus that are provided in the embodiments of the present application, an exception on the host can be avoided while the backup power supply module supplies backup power to the host for a longer time, so that the processor in the host can normally store the to-be-stored data of the memory.

In the scenario 2, according to the backup power supply method and the apparatus that are provided in the embodiments of the present application, after detecting that the host is powered on, the power-on/off management device in the host may set a power-on/off flag to a power-on flag. Therefore, when the processor in the host detects that the power-on/off flag is the power-on flag, the processor may restore, to the memory, the to-be-restored data (the data stored by the processor from the memory to the backup power hard disk when the host is powered off) stored in the backup power hard disk, and then the processor boots an operating system of the host. In this way, after being normally booted, the host can restore to the state in which the host is before being powered off.

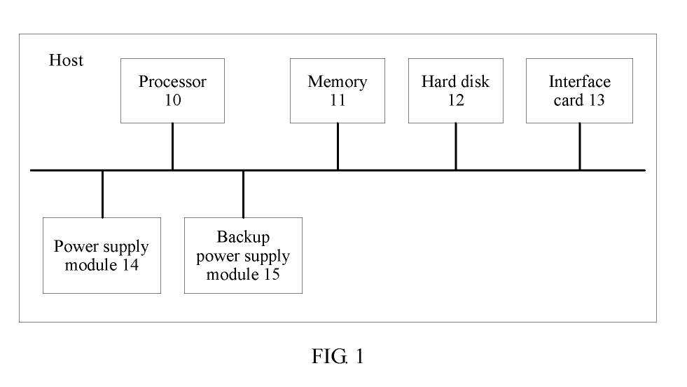

FIG. 1 is a schematic hardware diagram of a host according to an embodiment of the present application. As shown in FIG. 1, the host provided in this embodiment of the present application may include a processor 10, a memory 11, a hard disk 12, an interface card 13, a power supply module 14, and a backup power supply module 15. The following further illustrates the components in the host.

The processor 10 is a core component in the host and is configured to run an operating system of the host and application programs (including a system application program and a third-party application program) on the host.

In this embodiment of the present application, the processor may be specifically a central processing unit (central processing unit, CPU).

The memory 11 is an internal memory in the host and is configured to store, in a host running process, a program and data that are related to a processor running process. The memory may be a RAM: a static random access memory (static RAM, SRAM) or a dynamic random access memory (dynamic RAM, DRAM).

The hard disk 12 is an external memory in the host and is configured to persistently store a related program and related data. The hard disk may be a Serial Advanced Technology Attachment (serial advanced technology attachment, SATA) disk, may be an integrated drive electronics (integrated drive electronics, IDE) disk, or may be another type of hard disk.

The hard disk 12 may include a system disk and a data disk. There may be at least one system disk. In addition, there may be at least one data disk.

It should be noted that, a backup power hard disk in this embodiment of the present application may be the system disk or may be the data disk. The backup power hard disk may be selected based on an actual usage requirement. This is not limited in this embodiment of the present application. When the backup power hard disk provided in this embodiment of the present application is the system disk, the system disk may be the SATA disk. The SATA disk may be a mini SATA (mini SATA, mSATA) disk. The mSATA disk has a smaller volume, a larger capacity, and higher performance than the SATA disk, and therefore can better adapt to a supercomputer environment.

The interface card 13 is a function element connected to the host. The host can implement a corresponding function by using the interface card. The interface card may be a PCIe interface card. The PCIe interface card may include a video card, an audio card, a network interface card, and the like.

The power supply module 14 is configured to supply power to the elements in the host by using an external power source.

The backup power supply module 15 is configured to supply backup power to the elements in the host when the host is powered off. Because a battery capacity of the backup power supply module is usually limited, the backup power supply module can supply backup power to the host only for a short time when the host is powered off. The backup power supply module may be usually a battery module, a capacitor module (namely, a capacitor backup unit (capacitor backup unit, CBU)), or a module that can supply backup power.

For clearer understanding of the technical solutions in the present application, the following separately uses the foregoing two application scenarios (namely, the scenario 1 and the scenario 2) as examples to illustrate the backup power supply method provided in the embodiments of the present application.

Scenario 1: Backup power is supplied to the host when the host is powered off.

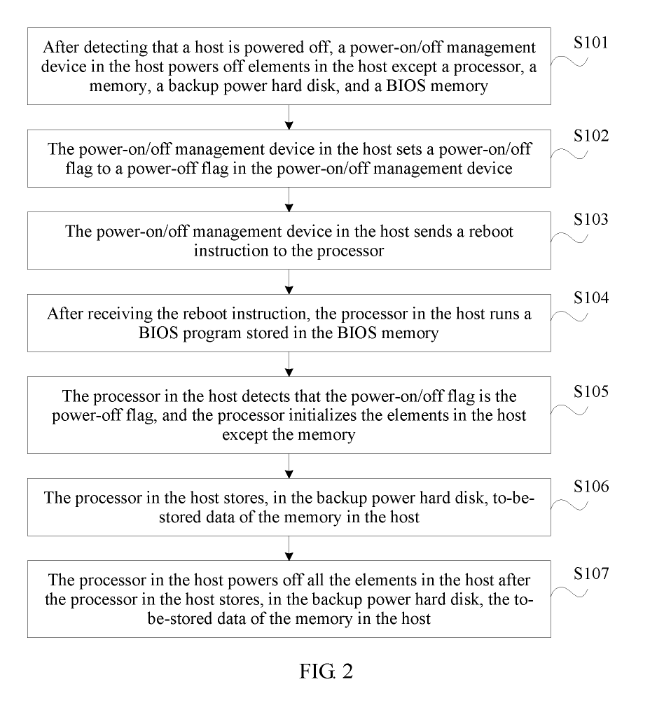

With reference to FIG. 1, as shown in FIG. 2, an embodiment of the present application provides a backup power supply method. The method may include the following steps.

S101. After detecting that a host is powered off, a power-on/off management device in the host powers off elements in the host except a processor, a memory, a backup power hard disk, and a BIOS memory.

In this embodiment of the present application, when the host is powered off, because the memory is a volatile storage medium, data of the memory may be lost. To ensure that the data of the memory is not lost, a backup power supply module may be used to supply backup power to the host, and during the backup power supply, the processor in the host stores, in the backup power hard disk, to-be-stored data of the memory.

In this embodiment of the present application, there may be one or more backup power supply modules. In other words, one backup power supply module may supply backup power to the host, or a plurality of backup power supply modules may simultaneously supply backup power to the host. A specific quantity of backup power supply modules may be selected based on an actual usage requirement. This is not limited in this embodiment of the present application.

Optionally, in this embodiment of the present application, a plurality of backup power supply modules supply backup power to the host. Therefore, when the host is powered off, a larger quantity of electricity of backup power can be supplied to the host or backup power can be supplied to the host for a longer time. In addition, if one of the plurality of backup power supply modules is faulty, a backup power supply module in the plurality of backup power supply modules other than the backup power supply module may further supply backup power to the host. In this way, it can be more reliable for the backup power supply module to supply backup power to the host when the host is powered off.

In this embodiment of the present application, when the host is powered off, some elements (namely, the elements except the processor, the memory, the backup power hard disk, and the BIOS memory, briefly referred to as elements that need no backup power supply below) in the host may not need to operate in a process of storing the to-be-stored data of the memory. In other words, in the process of storing the to-be-stored data of the memory, there may be no need to supply backup power to the elements that need no backup power supply. Therefore, in the backup power supply method provided in this embodiment of the present application, the host (may be specifically the power-on/off management device in the host) can power off the elements that need no backup power supply. In this way, the backup power supply module can supply backup power to the host for a longer time, and a backup power supply capability of the backup power supply module can be improved.

Further, the backup power supply module supplies backup power to the host for a longer time. Therefore, it can be ensured, to a specific degree, that all the to-be-stored data of the memory is successfully stored.

Optionally, in this embodiment of the present application, the elements that need no backup power supply may include a PCIe interface card, a data disk, a fan, and the like. The data disk is not the foregoing backup power hard disk.

S102. The power-on/off management device in the host sets a power-on/off flag to a power-off flag in the power-on/off management device.

S103. The power-on/off management device in the host sends a reboot instruction to the processor.

In this embodiment of the present application, the power-on/off flag may be used to indicate whether the host is in a power-off state or in a power-on state. Herein, that the power-on/off flag is the power-off flag may specifically indicate that the host is in the power-off state. Specifically, when the host is powered off, the power-on/off management device in the host may detect that the host is powered off, and set the power-on/off flag to the power-off flag in the power-on/off management device. In this way, the processor in the host can detect the power-on/off flag, to learn of a current state of the host, for example, learn that the host is currently in the power-off state.

For example, in this embodiment of the present application, the power-off flag may be specifically indicated by using “0” or “1”. For example, “0” may be used to indicate that the host is in the power-off state, or “1” may be used to indicate that the host is in the power-off state. Certainly, in this embodiment of the present application, other flags that meet an actual usage requirement may be used to set the power-off flag, and are not listed one by one in this embodiment of the present application.

Optionally, the power-on/off flag may be stored in a register in the power-on/off management device in the host.

In this embodiment of the present application, the host may encounter an exception after the power-on/off management device in the host powers off the elements in the host that need no backup power supply. Therefore, after the power-on/off management device powers off the elements in the host that need no backup power supply and sets the power-on/off flag to the power-off flag, the power-on/off management device can send the reboot instruction to the processor in the host, to reboot the processor. In this way, the following case can be avoided: The host encounters an exception after the power-on/off management device powers off the elements in the host that need no backup power supply.

S104. After receiving the reboot instruction, the processor in the host runs a BIOS program stored in the BIOS memory.

In this embodiment of the present application, after the processor in the host receives the reboot instruction sent by the power-on/off management device in the host, the processor is rebooted. The processor first runs the BIOS program during rebooting, and the BIOS program can provide the host with most underlying and most direct hardware and/or software setting and control. Therefore, in this embodiment of the present application, the processor can store the to-be-stored data of the memory in a process of running the BIOS program.

S105. The processor in the host detects that the power-on/off flag is the power-off flag, and the processor initializes the elements in the host except the memory.

In this embodiment of the present application, when the host is powered off, the to-be-stored data of the memory needs to be stored, the processor in the host first needs to initialize the elements in the host after being rebooted, and the power-on/off management device in the host sets the power-on/off flag to the power-off flag. Therefore, after the processor in the host is rebooted, if the processor in the host detects that the power-on/off flag is the power-off flag, to prevent the to-be-stored data of the memory from being initialized during initialization of the elements, the processor in the host may not initialize the memory during the initialization of the elements in the host. In other words, the processor in the host initializes all the elements in the host except the memory. For example, the processor in the host initializes these elements in the host other than the memory that are the processor, the backup power hard disk, the BIOS memory, and the like and to which the backup power supply module supplies backup power.

S106. The processor in the host stores, in the backup power hard disk, to-be-stored data of the memory in the host.

Optionally, in this embodiment of the present application, before the processor in the host stores, in the backup power hard disk, the to-be-stored data of the memory in the host, the processor in the host may further determine a state of the backup power hard disk in the host, and select a normal-state backup power hard disk as the backup power hard disk that stores the to-be-stored data of the memory. For example, the processor in the host may determine whether the backup power hard disk in the host is in position (for example, whether the backup power hard disk is normally connected to the host) and whether data can be normally written to or read from the backup power hard disk, to determine whether the backup power hard disk is in a normal state or in an abnormal state.

In this embodiment of the present application, one or more backup power hard disks may be configured to store the to-be-stored data of the memory. Specifically, a backup power hard disk that needs to be used may be selected based on an actual usage requirement. This is not limited in this embodiment of the present application.

Optionally, when a plurality of backup power hard disks are configured to store the to-be-stored data of the memory, the host may select a normal backup power hard disk to store the to-be-stored data of the memory. In this way, it can be more reliable for the host to successfully store the to-be-stored data of the memory.

In this embodiment of the present application, the method for storing, in the backup power hard disk by the processor in the host, the to-be-stored data of the memory in the host may be specifically as follows: The processor in the host first reads the to-be-stored data from the memory in the host, and then the processor in the host writes the to-be-stored data to the backup power hard disk.

It should be noted that, the to-be-stored data of the memory may be all data of the memory or data of a cache obtained after the memory is partitioned. Specific to-be-stored data may be determined based on an actual requirement. This is not limited in this embodiment of the present application.

In this embodiment of the present application, in a process in which the processor in the host stores, in the backup power hard disk, the to-be-stored data of the memory in the host, the processor in the host may further send a cache clear command (namely, a flush command) to the backup power hard disk. The flush command is used to instruct the processor in the host to write, to a persistent storage medium in the backup power hard disk, all data of a cache in the backup power hard disk.

It should be noted that, in a process of storing, in the backup power hard disk, the to-be-stored data of the memory, the to-be-stored data of the memory is first written to the cache in the backup power hard disk, and then is written from the cache in the backup power hard disk to a non-volatile storage medium in the backup power hard disk. Therefore, to ensure that all the data of the cache in the backup power hard disk is written to the persistent storage medium in the backup power hard disk, the processor in the host may send the flush command to the backup power hard disk.

Optionally, after all the to-be-stored data of the memory is stored in the backup power hard disk, the processor in the host may further set a data storage validity flag that is used to indicate that all the to-be-stored data of the memory is successfully stored.

S107. The processor in the host powers off all the elements in the host after the processor in the host stores, in the backup power hard disk, the to-be-stored data of the memory in the host.

The processor in the host can power off all the elements in the host after the processor in the host writes, to the backup power hard disk, all the to-be-stored data of the memory in the host. So far, the to-be-stored data of the memory in the host is stored when the host is powered off.

According to the backup power supply method provided in this embodiment of the present application, when the power-on/off management device in the host detects that the host is powered off, the power-on/off management device can power off the elements in the host except elements (for example, the processor, the memory, the backup power hard disk, and the BIOS memory) that need a backup power supply. In other words, the backup power supply module supplies backup power only to the elements in the host that need a backup power supply. Therefore, compared with the prior art, in this embodiment of the present application, the backup power supply module can supply backup power to the host for a longer time. In addition, after the power-on/off management device in the host powers off the elements in the host except the elements that need a backup power supply, the power-on/off management device can send the reboot instruction to the processor in the host, to reboot the processor. After being rebooted, the processor runs the BIOS program to: detect that the power-on/off flag is the power-off flag, and initialize the elements in the host except the memory; and store, in the backup power hard disk, the to-be-stored data of the memory, and then power off all the elements in the host. Therefore, compared with the prior art, in this embodiment of the present application, the following case can be avoided: The host encounters an exception after the power-on/off management device in the host powers off the elements in the host except the elements that need a backup power supply, so that the processor in the host can normally store the to-be-stored data of the memory. In this way, according to the backup power supply method provided in this embodiment of the present application, an exception on the host can be avoided while the backup power supply module supplies backup power to the host for a longer time, so that the processor in the host can normally store the to-be-stored data of the memory.

Scenario 2: The host is powered on again after the host is powered off.

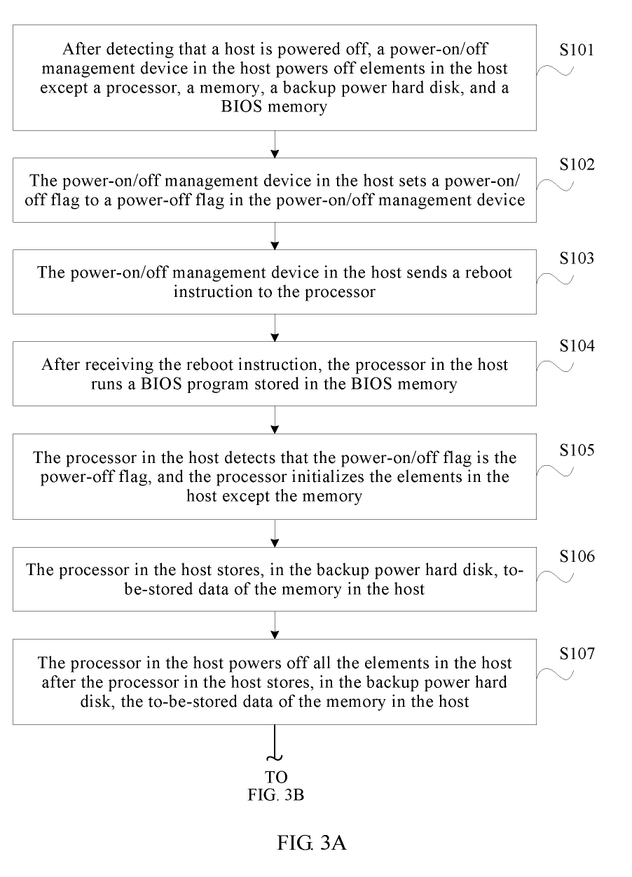

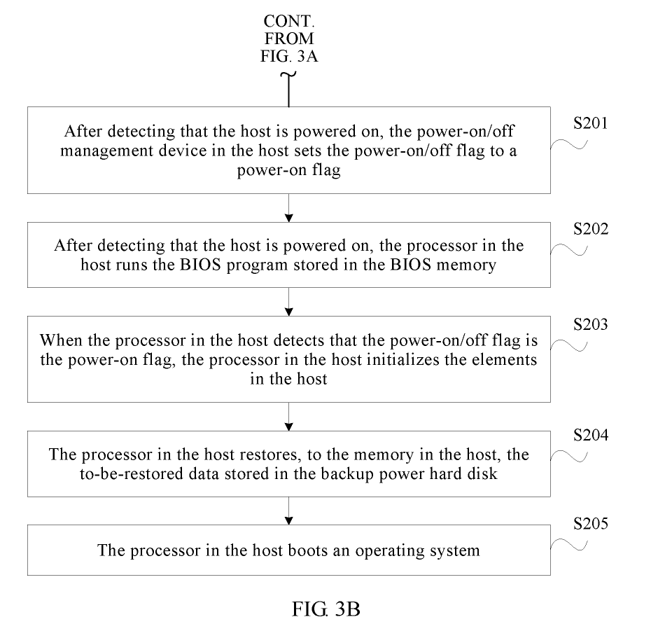

With reference to FIG. 2, as shown in FIG. 3A and FIG. 3B, the backup power supply method provided in the embodiments of the present application may further include the following steps.

S201. After detecting that the host is powered on, the power-on/off management device in the host sets the power-on/off flag to a power-on flag.

For detailed descriptions of the power-on/off flag, refer to the foregoing related descriptions of the power-on/off flag in S102. Details are not described herein again.

In this embodiment of the present application, that the power-on/off flag is the power-on flag may be used to indicate that the host is in the power-on state. Specifically, when the host is powered on, the power-on/off management device in the host may detect that the host is powered on, and set the power-on/off flag to the power-on flag in the power-on/off management device. In this way, the processor in the host can detect the power-on/off flag, to learn of a current state of the host, for example, learn that the host is currently in the power-on state.

For example, in this embodiment of the present application, the power-on flag may be specifically indicated by using “0” or “1”. For example, “0” may be used to indicate that the host is in the power-on state, or “1” may be used to indicate that the host is in the power-on state. Certainly, in this embodiment of the present application, other flags that meet an actual usage requirement may be used to set the power-on flag, and are not listed one by one in this embodiment of the present application.

It should be noted that, in this embodiment of the present application, the to-be-stored data of the memory needs to be stored after the host is powered off, and the to-be-restored data stored in the backup power hard disk needs to be restored after the host is powered on. Therefore, when both the power-off flag and the power-on flag are used in this embodiment of the present application, different values may be used to indicate the power-off flag and the power-on flag. For example, with reference to the foregoing descriptions in S102, if “0” is used to indicate the power-off flag, “1” may be used to indicate the power-on flag; if “1” is used to indicate the power-off flag, “0” may be used to indicate the power-on flag.

S202. After detecting that the host is powered on, the processor in the host runs the BIOS program stored in the BIOS memory.

The BIOS program can provide the host with most underlying and most direct hardware and/or software setting and control. Therefore, in this embodiment of the present application, the processor can restore, in a process of running the BIOS program, the to-be-restored data stored in the backup power hard disk.

In this embodiment of the present application, the processor in the host first runs the BIOS program after the host is powered on.

S203. When the processor in the host detects that the power-on/off flag is the power-on flag, the processor in the host initializes the elements in the host.

In this embodiment of the present application, when the host is powered on, the processor in the host first needs to initialize the elements in the host after being normally booted, and the power-on/off management device in the host sets the power-on/off flag to the power-on flag. Therefore, after the processor in the host is normally booted, if the processor in the host detects that the power-on/off flag is the power-on flag, the processor in the host can initialize all the elements in the host. For example, the processor in the host initializes all the elements in the host, for example, an interface card, a register, a PCI controller, and the memory. In this way, it can be ensured that all the elements in the host can normally operate after the processor in the host is normally booted.

S204. The processor in the host restores, to the memory in the host, the to-be-restored data stored in the backup power hard disk.

Optionally, according to the backup power supply method provided in this embodiment of the present application, in a process of running the BIOS program, the processor in the host may configure, in the memory in the host, a size of a cache in the processor based on a requirement of a service performed before the host is powered off. For example, a size of the memory in the host is 64 GB. The processor in the host may partition the memory to obtain a 2 GB partition as the cache in the processor.

Optionally, in this embodiment of the present application, in the process of running the BIOS program, the processor in the host may first initialize all the components in the host, and then configure the size of the cache in the processor in the host based on the requirement of the service. In this way, the following problem can be avoided: A configured cache becomes invalid because a size of the configured cache is initialized.

Optionally, in this embodiment of the present application, before the processor in the host restores the to-be-restored data stored in the backup power hard disk, the processor in the host may further determine a state of the backup power hard disk in the host, select a normal-state backup power hard disk that stores the to-be-restored data, and then restore the to-be-restored data in the backup power hard disk to the memory. For example, the processor in the host may determine whether the backup power hard disk in the host is in position (to be specific, whether the backup power hard disk is normally connected to the host) and whether data can be normally written to or read from the backup power hard disk, to determine whether the backup power hard disk is in a normal state or in an abnormal state.

Optionally, after the processor in the host selects the normal-state backup power hard disk that stores the to-be-restored data, the processor in the host may further determine whether the to-be-restored data stored in the backup power hard disk is valid (to be specific, whether the processor in the host has successfully stored, in the backup power hard disk, all the to-be-stored data of the memory when the host is powered off). Specifically, the processor in the host may read the data storage validity flag that is set by the processor in the host after all the to-be-stored data is successfully stored in a process of storing the to-be-stored data of the memory, to learn that the to-be-restored data stored in the backup power hard disk is valid.

For example, in this embodiment of the present application, the data storage validity flag may be indicated by using “0” or “1”. For example, “0” may be used to indicate that the to-be-restored data in the backup power hard disk is valid, or “1” may be used to indicate that the to-be-restored data in the backup power hard disk is valid. Certainly, in this embodiment of the present application, other values that meet an actual usage requirement may be used to indicate the data storage validity flag, and are not listed one by one in this embodiment of the present application.

In this embodiment of the present application, the method for restoring, to the memory in the host by the processor in the host, the to-be-restored data stored in the backup power hard disk may be specifically as follows: The processor in the host first reads the to-be-restored data from the backup power hard disk, and then the processor in the host writes the to-be-restored data to the memory in the host.

S205. The processor in the host boots an operating system.

After the processor in the host restores, to the memory in the host, the to-be-restored data stored in the backup power hard disk, the processor in the host can boot the operating system, so that the processor in the host can run each service software to perform a corresponding service.

It should be noted that, in this embodiment of the present application, when the host is powered off, the to-be-stored data of the memory in the host can be stored in the backup power hard disk by performing S101 to S107 shown in FIG. 2. When the host is powered on again after being powered off, the to-be-restored data stored in the backup power hard disk can be restored to the memory in the host by performing S201 to S205 shown in FIG. 3A and FIG. 3B.

In this embodiment of the present application, S101 to S107 and S201 to S205 may be separately performed. To be specific, S101 to S107 are performed when the host is powered off, or S201 to S205 are performed when the host is powered on again after being powered off. Certainly, as shown in FIG. 3A and FIG. 3B, S101 to S107 and S201 to S205 may be performed together. To be specific, S101 to S107 are performed when the host is powered off, and S201 to S205 are performed when the host is powered on again after being powered off. Specifically, a specific execution manner may be selected based on an actual usage requirement. This is not limited in this embodiment of the present application.

In this embodiment of the present application, after detecting that the host is powered on, the power-on/off management device in the host may set the power-on/off flag to the power-on flag. Therefore, when the processor in the host detects that the power-on/off flag is the power-on flag, the processor may restore, to the memory, the to-be-restored data (the data stored by the processor from the memory to the backup power hard disk when the host is powered off) stored in the backup power hard disk, and then the processor boots the operating system of the host. In this way, after being normally booted, the host can restore to a state in which the host is before being powered off.

Optionally, in this embodiment of the present application, when the host is normally running, a power supply module in the host may charge the backup power supply module, and system management software that is run by the processor in the host can monitor, in real time, whether the backup power supply module is fully charged. Therefore, a charging status of the backup power supply module can be learned of in real time. If the backup power supply module is fully charged, it indicates that the memory in the host can be normally used (to be specific, the following case is avoided: Electric power is insufficient to ensure that all the data of the memory is successfully stored when the host is powered off). If the backup power supply module is not fully charged, it indicates that the memory in the host cannot be normally used.

Optionally, the system management software that is run by the processor in the host can further monitor, in real time, whether the backup power supply module is faulty, and generate an alarm when the backup power supply module is faulty. In this way, it can be ensured that a fault occurring in the backup power supply module is found in a timely manner. For example, the system management software that is run by the processor in the host notifies service software executed by the processor in the host that the memory in the host cannot be normally used in this case.

In this embodiment of the present application, in the foregoing process, it can be ensured that the memory in the host is normally used, and it can be ensured that all the data of the memory in the host is successfully stored when the host is powered off.

An embodiment of the present application provides a host. The host may include a processor, a memory, a backup power hard disk, a power-on/off management device, and a BIOS memory. The host may further include an interface card, a power supply module, a backup power supply module, and the like. The processor may be specifically a CPU.

Alternatively, the processor may be another general purpose processor, a digital signal processor (English: digital signal processor, DSP for short), an application-specific integrated circuit (English: application-specific integrated circuit, ASIC for short), a field-programmable gate array (English: field-programmable gate array, FPGA) or another programmable logic device, a discrete gate or a transistor logic device, a discrete hardware component, or the like. The general purpose processor may be a microprocessor, or the processor may be any conventional processor or the like.

The power-on/off management device in the host may be specifically a CPLD.

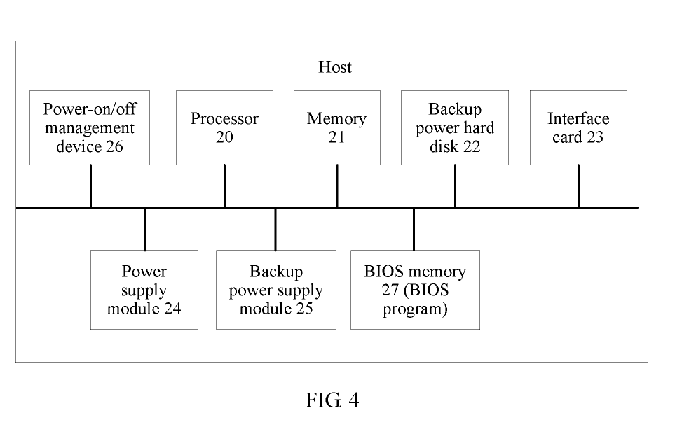

With reference to the host shown in FIG. 1, as shown in FIG. 4, the host provided in this embodiment of the present application may include a processor 20, a memory 21, a backup power hard disk 22, an interface card 23, a power supply module 24, a backup power supply module 25, a power-on/off management device 26, a BIOS memory 27, and the like. The processor 20 may run a BIOS program in the BIOS memory 27. The backup power hard disk shown in FIG. 4 may be a system disk, or may be a data disk. The elements in the host may be used to perform the steps in the method procedure shown in FIG. 2 and/or FIG. 3A and FIG. 3B.

For clearer understanding of the technical solutions in the present application, the following separately uses the foregoing two application scenarios (namely, the scenario 1 and the scenario 2) as examples to illustrate the host provided in this embodiment of the present application.

In the scenario 1, the processor 20 is specifically configured to perform S104 to S107 in the method embodiment shown in FIG. 2, and the power-on/off management device 26 is specifically configured to perform S101 and S103 in the method embodiment.

In the scenario 2, the processor 20 is specifically configured to perform S202 to S205 in the method embodiment shown in FIG. 3A and FIG. 3B, and the power-on/off management device 26 is specifically configured to perform S201 in the method embodiment.

An embodiment of the present application further provides a computer readable storage medium. The computer readable storage medium stores one or more programs, the one or more programs include an instruction, and the processor and the power-on/off management device in the foregoing host can execute the instruction to perform the method procedure shown in FIG. 2 and/or FIG. 3A and FIG. 3B.

According to the host provided in this embodiment of the present application, when the power-on/off management device in the host detects that the host is powered off, the power-on/off management device can power off the elements in the host except elements (for example, the processor, the memory, the backup power hard disk, and the BIOS memory) that need a backup power supply. In other words, the backup power supply module supplies backup power only to the elements in the host that need a backup power supply. Therefore, compared with the prior art, in this embodiment of the present application, the backup power supply module can supply backup power to the host for a longer time. In addition, after the power-on/off management device in the host powers off the elements in the host except the elements that need a backup power supply, the power-on/off management device can send a reboot instruction to the processor in the host, to reboot the processor. After being rebooted, the processor runs the BIOS program to: detect that a power-on/off flag is a power-off flag, and initialize the elements in the host except the memory; and store, in the backup power hard disk, to-be-stored data of the memory, and then power off all the elements in the host. Therefore, compared with the prior art, in this embodiment of the present application, the following case can be avoided: The host encounters an exception after the power-on/off management device in the host powers off the elements in the host except the elements that need a backup power supply, so that the processor in the host can normally store the to-be-stored data of the memory. In this way, according to the host provided in this embodiment of the present application, an exception on the host can be avoided while the backup power supply module supplies backup power to the host for a longer time, so that the processor in the host can normally store the to-be-stored data of the memory.

Further, according to the host provided in this embodiment of the present application, after detecting that the host is powered on, the power-on/off management device in the host may set the power-on/off flag to a power-on flag. Therefore, when the processor in the host detects that the power-on/off flag is the power-on flag, the processor may restore, to the memory, the to-be-restored data (the data stored by the processor from the memory to the backup power hard disk when the host is powered off) stored in the backup power hard disk, and then the processor boots an operating system of the host. In this way, after being normally booted, the host can restore to a state in which the host is before being powered off.

Based on the foregoing descriptions of implementations, a person skilled in the art can clearly understand that, for the purpose of convenient and brief description, division of the foregoing function modules is merely used as an example for illustration. During actual application, the foregoing functions can be allocated to different modules for implementation based on a requirement. To be specific, an inner structure of an apparatus is divided into different function modules to implement all or some of the functions described above. For a detailed working process of the system, apparatus, and unit that are described above, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, the module or unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, to be specific, may be located in one position, or may be distributed on a plurality of network units. Some or all of the units may be selected based on an actual requirement to achieve the objectives of the solutions in the embodiments.

In addition, the function units in the embodiments of the present application may be integrated into one processing unit, or each of the units may exist alone physically, or two or more units are integrated into one unit. The integrated unit may be implemented in a form of hardware, or may be implemented in a form of a software function unit.

When the integrated unit is implemented in the form of a software function unit and sold or used as an independent product, the integrated unit may be stored in a computer readable storage medium. Based on such an understanding, the technical solutions in the present application essentially, or the part contributing to the prior art, or all or some of the technical solutions may be implemented in a form of a software product. The computer software product is stored in a storage medium and includes several instructions for instructing a computer device (which may be a personal computer, a server, a network device, or the like) to perform all or some of the steps in the method described in the embodiments of the present application. The storage medium includes any medium that can store program code, such as a flash memory, a removable hard disk, a read-only memory, a random access memory, a magnetic disk, or an optical disc.

The foregoing descriptions are merely specific implementations of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A backup power supply method, applied to a host, wherein the method comprises:
after detecting that the host is powered off, performing, by a power-on/off management device of the host, the following operations:
powering off elements in the host except a processor, a memory, a hard disk, and a basic input/output system (BIOS) memory;
setting a power-off flag in the power-on/off management device; and
sending a reboot instruction to the processor; and
after receiving the reboot instruction, running, by the processor, a BIOS program stored in the BIOS memory, to perform the following operations:
initializing the elements in the host except the memory when the power-off flag is detected;
storing to-be-stored data of the memory in the hard disk; and
powering off all the elements in the host after storing the to-be-stored data in the hard disk.

2. The method according to claim 1, wherein the method further comprises:
after detecting that the host is powered on, setting, by the power-on/off management device in the host, a power-on flag;
when detecting the power-on flag, restoring, by the processor, the to-be-restored data stored in the hard disk to the memory; and
booting an operating system.

3. A host comprising a power-on/off management device, a processor, a memory, a hard disk, and a basic input/output system BIOS memory;
the power-on/off management device is configured to: after detecting that the host is powered off, power off elements in the host except the processor, the memory, the hard disk, and the BIOS memory; and set a power-off flag in the power-on/off management device, and send a reboot instruction to the processor; and
the processor is configured to: after receiving the reboot instruction, run a BIOS program stored in the BIOS memory, to initialize the elements in the host except the memory when detecting the power-off flag; store to-be-stored data of the memory into the hard disk;
and power off all the elements in the host after storing the to-be-stored data into the hard disk.

4. The host according to claim 3, wherein
the power-on/off management device is further configured to: after detecting that the host is powered on, set a power-on flag; and
the processor is further configured to: when detecting the power-on flag, restore the to-be-restored data stored in the hard disk to the memory; and boot an operating system.
